(19) United States
(12) Patent Application Publication
(10) Pub. No.: US 2022/0030652 A1
(43) Pub. Date: Jan. 27, 2022

(54) RADIO-COMMUNICATION SYSTEM RESISTANT TO RADIO DISTURBANCES

(71) Applicant: VOGO, Montpellier (FR)

(72) Inventors: Rémy VINCENT, Grenoble (FR); Pascal SAGUIN, Crets En Belledonne (FR); Jérôme SCANDELLA, La Boisse (FR); Fabien DE BARROS, Pontcharra (FR)

(73) Assignee: VOGO, Montpellier (FR)

(21) Appl. No.: 17/383,583

(22) Filed: Jul. 23, 2021

(30) Foreign Application Priority Data
Jul. 23, 2020 (EP) 20305846.6

(51) Int. Cl. H04W 76/15; H04W 72/04; H04W 72/08

(52) U.S. Cl. CPC H04W 76/15; H04W 72/085; H04W 72/0453

(57) ABSTRACT

The invention concerns a method for radio-communication between a primary communication device (Prim) and at least one secondary communication device (Sec), the primary (Prim) and secondary (Sec) communication devices constituting the radio-communication system (S), the radio-communication method using an application carrier frequency (fpa) for the transmission of an application datum (A), the primary communication device (Prim) sending an information packet (B) and receiving a piece of information BER and PER originating from the at least one secondary communication device (Sec).

### TECHNICAL FIELD OF THE INVENTION

The invention concerns a method for radio-communication between a primary communication device and at least one secondary communication device comprised in a group of secondary communication devices.

More particularly, the invention concerns a radio-communication method carried out in real-time, in other words immediately and without delay.

### STATE OF THE ART

Methods for radio-communication between a primary communication device and at least one secondary communication device may be subjected to disturbances generally present on the communication channels. These disturbances are detrimental to the radio-communication systems as the useful datum or application datum transmitted from one device to another such as voice, becomes unusable upon reception.

There are various radio-communication methods allowing for the resistance of the radio-communication link to the disturbances generally present on the communication channels, also called carrier frequencies.

Thus, a first method consists in the static and manual selection of non-disturbed communication channels for the transmission of a signal. In this first method, the operator carries out for each communication channel a measurement of the reception power of a received signal which provides an indication on the intensity of the received signal, called RSSI standing for received signal strength indication. Thus, the operator can control communication devices of the network and change the communication channel between these devices.

However, in practice, the RSSI is difficult to measure because it fluctuates when an obstacle is interposed between two communication devices. Moreover, this method requires a presence of a dedicated operator and that the latter intervenes on all communication devices.

A second method consists in an addition of redundant information during the transmission of a signal between the communication devices. Time-division multiple access TDMA transmission protocols enable several users to share the same carrier frequency or communication channel by dividing the signal into radio packets transmitted in several time intervals or time slots. Each radio packet contains a definite number of information bits. A disturbance of the signal to be transmitted results in a modification of one information bit and therefore the radio packet containing this information bit becomes unusable upon reception. An information redundancy consists in replicating the same information several times in the signal to be transmitted so as to make the disturbed radio packets usable upon reception. An information redundancy may be carried out in two different manners: through a duplication of the radio packet, in this case the duplicated packet of the signal to be transmitted will be emitted at a different time point or on a different carrier frequency, or through an encoding of the radio packet and in this case the size of the radio packet of the signal to be transmitted will be larger but an encoding of the radio packet will allow restoring several information bits that have been disturbed within the radio packet.

However, the redundancy of transmitted information requires a wide frequency band and consequently, can be used only for a small number of communication devices when the available bandwidth is limited, in particular when the communication between the different devices is done in real-time. Moreover, the redundancy of transmitted information could increase a communication latency, which is not desirable in the context of a communication in real-time.

A third method comprises a spectrum spreading by frequency hopping or FHSS. It consists in the transmission of a signal by an emitter communication device to a receiver device, alternatively using several communication channels scattered in a frequency band according to a known quasi-random sequence of the emitter device and of the receiver device. This method confers a static immunity to a presence of possible disturbers.

However, the FHSS adopts a systematic approach for modifying the carrier frequency and worsens the congestion problem in the radio communications. Moreover, the use of the FHSS method is not possible in some geographic areas for standards-related reasons.

A fourth method enabling the resistance of the radio-communication link to disturbances consists in detecting the presence of a communication device emitting a signal—exceeding a determined power threshold, for example −62 dBm, on a communication channel before assigning after wards to the signal to be transmitted a communication channel where no other communication device is detected. The disturbance of the signal to be transmitted is thus avoided since it is transmitted on a carrier frequency on which no other device emits a signal at least as strong as the determined threshold. This is referred to as dynamic frequency selection (DFS).

However, this method requires a wide frequency band and the assignment of a carrier frequency is based on the measurement of the RSSI which, as previously set out, is difficult to measure in practice since it fluctuates when an obstacle is interposed between two communication devices.

The present invention aims at solving all or part of the aforementioned drawbacks.

### General Description

This aim could be achieved thanks to the implementation of a method for radio-communication between a primary communication device and at least one secondary communication device, the method using one or several application carrier frequenc(y/ies) for the transmission of an application datum, the method being executed by the primary communication device and comprising the following steps:
Receiving a piece of information relating to a quality of a communication link on at least one carrier frequency comprised in a first group of carrier frequencies originating from the at least one secondary communication device;
Carrying out a diagnostic of communication based on the information relating to the quality of the communication link on the at least one network carrier frequency;
Extracting a subgroup of carrier frequencies likely to become application carrier frequencies and carry a signal to be transmitted from the group of carrier frequencies;
Selecting the application carrier frequency in the subgroup of carrier frequencies;
Establishing an application communication between the primary communication device and the at least one secondary communication device on the application carrier frequency.

The method may also comprise the following step:
Sending the application datum to the secondary communication device on the application carrier frequency.

In the context of the invention, by applicative datum, it should be understood an audio datum and/or a video datum, or other types of data intended to be broadcast in real-time.

In the context of the invention, the radio-communication method that could use a communication on an application carrier frequency selected from a plurality of carrier frequencies may be called multichannel radio-communication method, the selection of the application carrier frequency corresponding to the definition of a communication channel.

According to one implementation, the reception of a piece of information relating to a plurality of a communication link is done on a plurality of network carrier frequencies comprised in a group of carrier frequencies originating from the at least one secondary communication device.

According to one possibility, carrying out a communication diagnostic from the piece of information relating to the communication link is done on a plurality of network carrier frequencies.

The arrangements according to the invention allow avoiding radio disturbances generally present on the communication channels: the primary and secondary communication devices are capable of detecting the disturbed communication channels without measuring the RSSI of the signal to be transmitted and to toggle, later on, in a standalone manner and without resorting to the services of an operator, on the non-disturbed communication channels for the transmission of the signal, while avoiding generating a congestion in the radio communications.

According to one implementation, the method may comprise the selection of several application carrier frequencies and the establishment of communication on a plurality of application carrier frequencies selected in the subgroup of carrier frequencies.

In particular, these arrangements apply when the radio-communication system is in an non-disturbed communication established state, the application datum may be transmitted on a plurality of carrier frequencies.

According to one implementation, the method comprises the step of sending an information packet on the at least one carrier frequency comprised in the group of carrier frequencies by the primary communication device towards the at least one secondary communication device.

According to one implementation, sending of information packets is carried out on a plurality of carrier frequencies comprised in the first group of carrier frequencies. In particular, sending may be carried out on all of the carrier frequencies comprised in the first group of carrier frequencies.

The step of receiving a piece of information relating to a quality of a communication link on different carrier frequencies (between the primary communication device and the at least one secondary communication device) originating from the slave unit corresponds to the determination of said piece of information from the reception of the information packet on different carrier frequencies.

According to one implementation, these arrangements correspond to a configuration in which the primary communication device is a master device and the secondary communication devices are slave devices.

According to one implementation, the information packet sent on the at least one carrier frequency comprised in the first group of carrier frequencies by the primary communication device to the at least one secondary communication device includes information for configuring the network and/or synchronizing the at least one secondary communication device.

According to one implementation, the radio-communication is carried out between a primary communication device and a group of secondary communication devices comprising at least one secondary communication device.

According to one possibility, during implementation of the method, the primary device could become a secondary device and, vice versa, a secondary device could become the primary device.

According to one implementation, the radio-communication may be carried out between a primary communication device and a group of secondary communication devices, the extraction of the subgroup of carrier frequencies may be done according to the following steps:
Assigning a partial mark for each secondary communication device comprised in the group of secondary communication devices for the at least one carrier frequency comprised in the group of carrier frequencies from the piece of information BER relating to the quality of the communication link on said carrier frequency received from said secondary communication device;
Determining an overall mark for the at least one carrier frequency comprised in the group of carrier frequencies from a plurality of partial marks for the carrier frequency obtained for a plurality of secondary communication devices comprised in the group of secondary communication devices;
Classifying the at least one carrier frequency in the subgroup of carrier frequencies based on the overall mark for the at least one carrier frequency.

According to one possibility, the subgroup of carrier frequencies P2 contains a number of carrier frequencies smaller than or equal to the number of carrier frequencies contained in the group of carrier frequencies P1.

According to one embodiment, the step of determining an overall mark for a frequency comprises the step of excluding at least one secondary communication device based on the partial mark assigned for the computation of the overall mark for the at least one carrier frequency comprised in the group of carrier frequencies.

According to these arrangements, a secondary communication device that has a bad mark for all carrier frequencies is excluded from the computation or from the determination of the computation of the overall mark.

According to one embodiment, the method further comprises the following steps:
Computing a piece of information relating to the quality of the transmission of the application datum emitted by the at least one secondary communication device on the application carrier frequency, and/or
Receiving the piece of information relating to the quality of the transmission of the application datum emitted by the primary communication device on the application carrier frequency, originating from the at least one secondary communication device;
Carrying out an application diagnostic on the application carrier frequency form the piece of information relating to the quality of the transmission of the application datum on the application carrier frequency;
Updating the subgroup of carrier frequencies from the application diagnostic on the application carrier frequency;
The following steps of the method being carried out again:
Selecting the application carrier frequency in the subgroup of carrier frequencies;
Establishing an application communication between the primary communication device and the at least one secondary communication device on the application carrier frequency.

According to one implementation, the selection of an application carrier frequency is done from the group of carrier frequencies.

According to one possibility, the update of the subgroup of carrier frequencies comprises a reclassification of the application carrier frequency based on the piece of information relating to the application carrier frequency in the subgroup of carrier frequencies if the piece of information relating to the application carrier frequency has an insufficient quality.

If, on the contrary, the piece of information relating to the application carrier frequency has enough quality, then the transmission of the application datum continues on the application frequency.

According to these arrangements, the piece of information relating to the communication link is an error rate relating to the packets sent by the primary communication device and received by the at least one secondary communication device.

Furthermore, the described radio-communication method is executed by the at least one secondary communication device and comprises the following steps:
Creating a piece of information relating to a quality of a communication link on at least one carrier frequency comprised in a group of carrier frequencies to be transmitted to the primary communication device;
Sending the piece of information relating to the quality of the communication link on at least one carrier frequency comprised in the group of carrier frequencies to the primary communication device.

According to one possibility, the described radio-communication method comprises the steps:
Receiving an information packet on the at least one carrier frequency comprised in the group of carrier frequencies originating from the primary communication device;
Configuring the at least one secondary communication device based on the information packet on the at least one carrier frequency comprised in the group of carrier frequencies originating from the primary communication device;
Synchronizing the at least one secondary communication device with the primary communication device based on the information packet on the at least one carrier frequency comprised in the group of carrier frequencies originating from the primary communication device.

According to one possibility, the described radio-communication method also comprises the steps:
Computing a piece of information relating to a quality of a transmission of an application datum emitted by the at least one secondary communication device on the application carrier frequency;
Sending the piece of information relating to the quality of the transmission of the application datum emitted by the at least one secondary communication device on the application carrier frequency to the primary communication device.

According to one implementation, the computation of the piece of information relating to the quality of the transmission of the application datum emitted by the at least one secondary communication device on the application carrier frequency is done over a time interval substantially comprised between 1 second and 10 seconds.

According to one possibility, a detection of a start and/or of an end of transmission of the application datum on the application carrier frequency is done prior to the computation of the piece of information relating to the quality of the transmission of the application datum on the application carrier frequency.

According to one implementation, the transmission of the application datum is done by a plurality of radio packets and the method is executed by the primary communication device and comprises the following steps:
A hierarchization of the primary communication device and of the at least one secondary communication device;
A prioritization for the transmission of the application datum on the application carrier frequency based on the hierarchization to designate a priority communication device;
A transmission of the application datum on the application carrier frequency by a plurality of radio packets with a redundancy of the application datum transmitted by the priority communication device.

For example, the priority communication device may refer to the communication device used by a central referee during a sporting event.

Moreover, for a radio-communication system implementing the described radio-communication method, is associated a method for managing the operation of said radio-communication system between a primary communication device and at least one secondary communication device, the system comprising a control center and the method being executed by the control center and comprising the following steps:
Receiving a piece of information relating to the operation of the radio-communication system by the control center;
Sending a piece of information relating to a management operation of the radio-communication system based on the piece of information relating to the operation of the radio-communication system for a modification of the operation of the primary radio-communication device and/or of the group of secondary radio-communication devices based on the piece of information.

According to one implementation, the piece of information relating to the operation of the radio-communication system is received from an information device belonging to the radio-communication system.

### DESCRIPTION WITH REFERENCE TO THE FIGURES

The invention will be better understood from the detailed description that is disclosed herein below with reference to the appended drawing in which:

FIG. 1 is a diagram representative of an embodiment of a system enabling the implementation of a radio-communication method according to the invention.

FIG. 2 is a diagram presenting the different types of data and information circulating upon the transmission of a radio-communication signal in the system of FIG. 1.

FIG. 3 is a diagram representing steps of a compression of an audio signal to be transmitted in the system of FIG. 1.

FIG. 4 is a sequence diagram representing different steps in the execution of the radio-communication method between a primary communication device and a secondary communication device of the system of FIG. 1.

FIG. 5 is a diagram describing a selection of an application carrier frequency for the transmission of an application datum in the method of FIG. 4.

FIG. 6 is a graph representing an assignment of a partial mark for a secondary communication device in the method of FIG. 4.

FIG. 7 is a diagram representing a communication between a control center and an information device belonging to the system of FIG. 1.

FIG. 8 is a flowchart representing steps of assigning application radio packets according to a specific role for a communication device implementing the radio-communication method described in FIG. 2.

FIG. 9 is a sequence diagram representing different steps describing a maintenance of the radio-communication system of FIG. 1.

In the following detailed description, in the figures defined hereinabove, the same elements or the elements filling identical functions may keep the same reference numerals in order to simplify understanding of the invention.

As represented in FIG. 1, an embodiment of a radio-communication system S enabling the implementation of a radio-communication method according to the invention, comprises a primary communication device Prim and a group of secondary communication devices comprising at least one secondary communication device Sec.

As represented in FIG. 1, a transmission of the application datum A is done between the primary communication device Prim and the group of secondary communication devices comprising the at least one secondary communication device Sec.

The primary communication device Prim may be configured to be carried on the body of a user of said primary device Prim.

In the same manner, the at least one secondary communication device Sec may be configured to be worn on the body of a user of said secondary device Sec.

According to one possibility, the primary device Prim and the at least one secondary communication device Sec are configured to be movable relative to a terrestrial reference frame.

For example, if the primary device Prim is worn by a referee who is moving during a football match, the primary device Prim is movable relative to the terrestrial reference frame. The same example may be given for the secondary device Sec.

A transmission of a piece of information BER, standing for Beacon Error Rate (in other words an error rate measured upon reception of a digital transmission between the primary communication device Prim and the at least one secondary communication device Sec relating to a first radio packet in the radio cycle called Beacon) relating to the quality of a communication link on at least one carrier frequency fp is done between the group of secondary communication devices and the primary communication device Prim and a transmission of an information packet B is done from the primary communication device Prim towards the group of secondary communication devices.

According to one possibility, the system also comprises a control center CT and an information device NAP. The information device NAP facilitates the creation of a communication link between the radio-communication system S and another network, for example the Internet network and for example in order to set the control center CT in communication with the radio-communication system S.

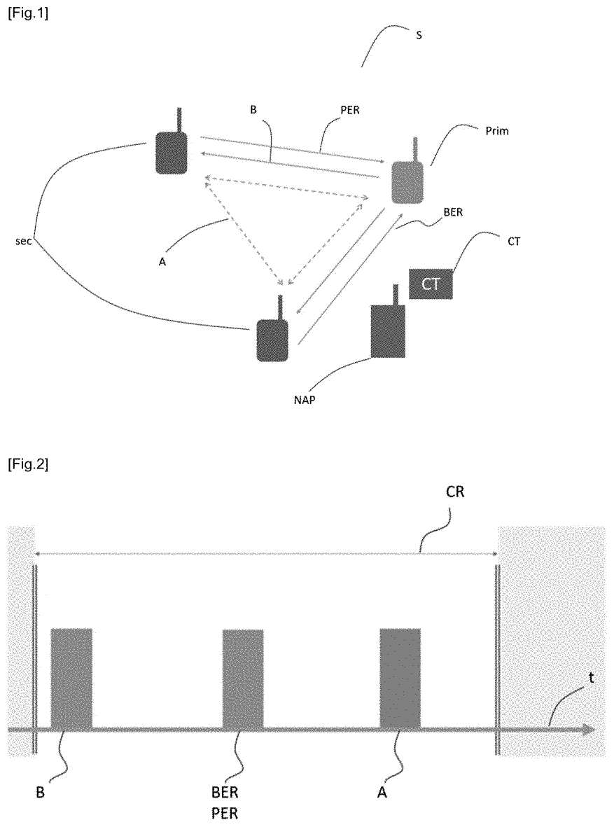

FIG. 2 presents the different types of data transmitted over time t between the primary device Prim and the group of secondary devices during a radio cycle CR according to one embodiment:
The application datum A: in the context of the invention, by application datum, it should be understood audio data and/or a video datum, or other types of data intended to be broadcast in real-type.
   Each device emits in a so-called “broadcast” mode the application datum A and a radio communication protocol ensures a full-duplex type communication. The application datum A is emitted on a set of carrier frequencies selected from a plurality of carrier frequencies since they ensure a better radio communication link.
Two types of information relating to a quality of a communication link on at least one carrier frequency: each secondary device Sec queried by the primary communication device Prim, transmits thereto a piece of information BER relating to the quality of a communication link and a piece of information relating to the quality of the transmission of an application datum PER (standing for Packet Error Rate which refers to an error rate relating to a number of packets that are not received or badly received by a communication device during the communication between the primary communication device Prim and the at least one secondary communication device Sec), which enable a detection of a deterioration of a communication link.
A piece of information B for synchronization and configuration on the at least one carrier frequency fp comprised in a group of carrier frequencies P1 by the primary communication device Prim towards the at least one secondary communication device Sec; the piece of information B is periodically emitted on a carrier frequency fp authorized by a local legislation.

According to one possibility, the piece of information B is transmitted on a different carrier frequency at each radio cycle.

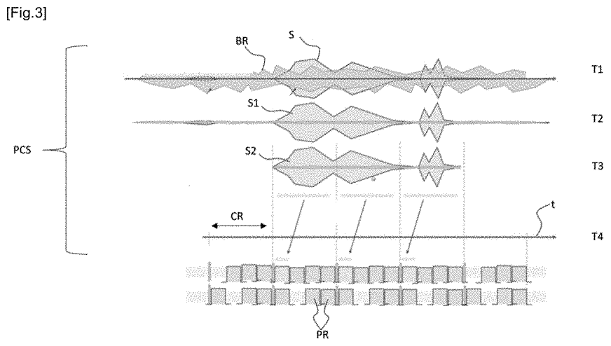

FIG. 3 presents a PCS method for digitizing and compressing a signal to be transmitted according to the radio-communication method. Said digitization and compression method allows processing a signal to be transmitted, for example an audio signal in order to ensure a clear communication in a noisy environment.

Thus, as represented in FIG. 3,

1. During a first step T1, a signal S to be transmitted is captured by a microphone which could be in the form of a micro-headset for example. The signal S could be drowned in a noisy background BR, for example a crown noise or a machine noise and cannot be exploited for a communication.

2. During a second step T2, the signal S is digitized and filtered to separate a noise-free second signal S1 thanks to signal processing algorithms which attenuate the noise by a value substantially equal to 30 dB. The signal S1 can therefore be exploited for a transmission.

3. During a third step T3, the signal S1 is processed by signal processing algorithms to extract again a new signal S2 which comprises useful information to be transmitted which refers to the application datum A. According to one embodiment, the useful information to be transmitted is for example a voice of a referee of a sporting event.

4. During a fourth step T4, the signal S2 is compressed into a plurality of radio packets PR. According to the invention the plurality of radio packets PR represents a time frame at a time point in the radio cycle CR, whose duration varies according to the amount of data to be transmitted.

In the used compression process, the plurality of radio packets PR are arranged in a cyclic manner over time t

In the used compression process, one single communication device can emit a signal S to be transmitted and on one single carrier frequency fp at once.

In the used compression process, a communication device that does not emit any signal to be transmitted, detects the signal transmitted by another communication device at a given time point on one single carrier frequency.

The above-described compression protocol corresponds for example to a time-division multiple access or TDMA type protocol.

In the described radio-communication method, an assignment of a time for the transmission of the application datum A is carried out dynamically, in other words a time interval in the radio cycle is not assigned to a specific communication device permanently, but rather temporarily, when the time interval is not already assigned to a transmission of a signal by another communication device and a communication device transmits the application datum A.

The advantage of the dynamic assignment of radio packets within a radio-communication system is to enable the use of a reduced number of radio packets available for the transmission of a signal by a large number of communication devices, in particular when the available radio packets are fewer than the communication devices.

Synchronization of the Radio Cycle by the Primary Communication Device

The communication devices must be synchronized during a time-division multiple access or TDMA type protocol in order to have a start time point of the radio cycle that is common to all communication devices and so that the position of the plurality of radio packets PR is accurately known, which enables the communication device to decrypt a signal emitted from another device and to transmit a signal that could be decrypted by the other communication devices.

In the described radio-communication method, the primary communication device guarantees the synchronization of the other communication devices.

The primary communication device emits a first radio packet in the radio cycle.

According to one possibility, the first radio packet is called information packet B or “Beacon” packet.

The secondary communication devices use the information packet B to synchronize themselves.

The primary communication device emits the information packet B repetitively so that the group of secondary communication devices could synchronize and thus avoid clock drifts internal to the communication devices.

The information packet B comprises a piece of information for configuring and parameterizing the group of secondary communication devices.

In the described radio-communication method, there are several types of transmission of a signal between the primary communication device and the at least one secondary communication device Sec contained in the group of secondary communication devices:
The piece of information B for configuring the radio-communication system originating from the primary communication device and addressed to the at least one secondary communication device Sec;
The application datum A, for example a voice of a referee of a sporting event, emitted by the primary communication device Prim or the at least one secondary communication device Sec towards the primary communication device Prim or the at least one secondary communication device Sec;
The piece of information BER and/or PER relating to the quality of the transmission of a signal within the radio-communication system.

The piece of information relating to a quality of a transmission of a signal within the radio-communication system could be a piece of information BER relating to a quality of a communication link on at least one carrier frequency fp comprised in a group of carrier frequencies P1 originating from the at least one secondary communication device Sec and towards the primary communication device Prim.

The piece of information relating to the quality of the transmission of the signal within the radio-communication system refers to a piece of information PER relating to the quality of the transmission of the application datum A emitted by the primary communication device Prim or the at least one secondary communication device Sec.

Description of the Radio-Communication Method

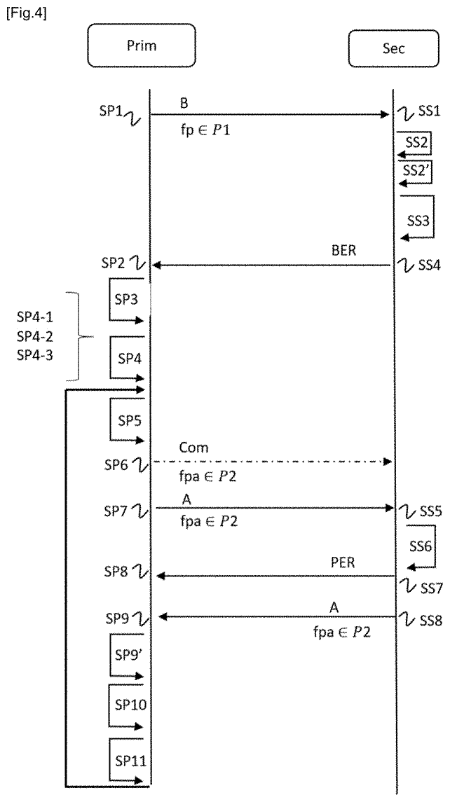

FIG. 4 presents a diagram of the sequences of the method for radio-communication between a primary communication device Prim and a secondary communication device Sec, the method using an application carrier frequency fpa for the transmission of the application datum A.

According to one implementation, these arrangements correspond to a configuration in which the primary communication device Prim is a master device and the group of secondary communication devices is a group of slave devices.

In the context of the invention, the radio-communication method which could use a communication on an application carrier frequency fpa selected from a plurality of carrier frequencies may be called multichannel radio-communication method, the selection of the application carrier frequency fpa corresponding to the definition of a communication channel.

According to one embodiment, the method comprises a step of sending SP1 an information packet B on the at least one carrier frequency fp comprised in the group of carrier frequencies P1 by the primary communication device Prim towards the at least one secondary communication device Sec.

The information packet B may be emitted by the primary communication device at each radio cycle on a different carrier frequency. The secondary communication devices may be synchronized upon reception of a packet B from the primary communication device. For example, the information packet B contains information for configuring the network and/or synchronizing the group of secondary communication devices which enable the group of secondary communication devices to track an emission sequence of the information packets B by the primary communication device Prim.

Following the sending step SP1 carried out by the primary communication device Prim, the at least one secondary communication device Sec proceeds with the reception SS1 of the information packet B on the at least one carrier frequency fp comprised in the group of carrier frequencies P1 originating from the primary communication device Prim. Then, takes place a step of configuring SS2 the at least one secondary communication device Sec based on the information packet B on the at least one carrier frequency fp comprised in the group of carrier frequencies P1 originating from the primary communication device Prim, as well as a step of synchronizing SS2′ the at least one secondary communication device Sec with the primary communication device Prim based on the information packet B on the at least one carrier frequency fp comprised in the group of carrier frequencies P1 originating from the primary communication device Prim.

Afterwards, the at least one secondary communication device proceeds with a Creation SS3 of a piece of information BER relating to the quality of the communication link on the at least one carrier frequency fp comprised in the group of carrier frequencies P1 to be transmitted to the primary communication device Prim as well as with sending SS4 of the piece of information BER relating to the quality of the communication link on the at least one carrier frequency fp comprised in the group of carrier frequencies P1 to the primary communication device Prim.

The piece of information BER may be considered as a statistic relating to the received disturbed packets B, for each carrier frequency. This statistic represents a piece of information relating to the quality of the communication link between the primary communication device and the secondary communication device.

The piece of information BER relating to the quality of the communication link may correspond to an error rate relating to the packets sent by the primary communication device Prim and received by the at least one secondary communication device Sec.

During a step SP2, the primary communication device receives the piece of information BER relating to the quality of the communication link on the at least one network carrier frequency fp comprised in a group of carrier frequencies P1 originating from the at least one secondary communication device Sec. The primary communication device carries out a step of carrying out SP3 a communication diagnostic based on the piece of information BER relating to the quality of the communication link on the at least one network carrier frequency fp, as well as an extraction SP4 of a subgroup of carrier frequencies P2 that might become application carrier frequencies and carry a signal to be transmitted from the group of carrier frequencies P1.

A selection SP5 of an application carrier frequency fpa in the subgroup of carrier frequencies P2 takes place followed by an establishment SP6 of an application communication Com between the primary communication device Prim and the at least one secondary communication device Sec on the application carrier frequency fpa.

According to one implementation, the reception of a piece of information BER relating to a quality of a communication link is done on a plurality of network carrier frequencies comprised in a group of carrier frequencies P1 originating from the at least one secondary communication device Sec.

According to one possibility, carrying out a communication diagnostic based on the information relating to the quality of the communication link is done on a plurality of network carrier frequencies.

According to one possibility, the extraction SP4 of the subgroup of carrier frequencies P2 is done according to the steps of assigning SP4-1 a partial mark for each secondary communication device Sec comprised in the group of secondary communication devices for the at least one carrier frequency fp comprised in the group of carrier frequencies P1 from the piece of information BER relating to the quality of the communication link on said carrier frequency fp received from said secondary communication device (Sec), of determining SP4-2 an overall mark for the at least one carrier frequency fp comprised in the group of carrier frequencies P1 from a plurality of partial marks for the carrier frequency fp obtained for a plurality of secondary communication devices comprised in the group of secondary communication devices, of classifying SP4-3 the at least one carrier frequency in the subgroup of carrier frequencies P2 based on the overall mark for the at least one carrier frequency fp.

The selection of the application carrier frequency fpa may be carried out by selecting the carrier frequency fp in the subgroup of carrier frequencies P2 having an overall mark meeting a determined criterion, for example a mark greater than or lower than a mark of other carrier frequencies in the case where the mark is based on an error rate.

According to one possibility, a plurality of application carrier frequencies may be selected for a communication over several application carrier frequencies.

Moreover, the step of determining SP4-2 an overall mark for one frequency comprises an exclusion of at least one secondary communication device Sec based on the partial mark assigned for the computation of the overall mark for the at least one carrier frequency fp comprised in the group of carrier frequencies P1.

According to one possibility, the subgroup of carrier frequencies P2 contains a number of carrier frequencies smaller than or equal to the number of carrier frequencies contained in the group of carrier frequencies P1.

According to one implementation, the reception of the piece of information BER relating to the quality of a communication link is done on a plurality of network carrier frequencies comprised in a group of carrier frequencies P1 originating from the at least one secondary communication device Sec.

According to one possibility, carrying out a communication diagnostic based on the information relating to the quality of the communication link is done on a plurality of network carrier frequencies.

Afterwards, the primary communication device Prim sends the application datum A towards the secondary communication device during a step SP7 on the application carrier frequency fpa.

Following the reception of the application datum A by the secondary communication device Sec at a step SS5 on the application carrier frequency fpa, the secondary communication device Sec carries out a step of computing SS6 a piece of information PER relating to a quality of a transmission of the application datum A emitted by the at least one secondary communication device Sec on the application carrier frequency fpa.

Then, the at least one secondary communication device proceeds with sending SS7 of the piece of information PER relating to the quality of the transmission of the application datum A emitted by the at least one secondary communication device Sec on the application carrier frequency fpa to the primary communication device Prim.

According to one implementation, the computation SS6 of the piece of information PER relating to the quality of the transmission of the application datum A emitted by the at least one secondary communication device Sec on the application carrier frequency fpa is done over a time interval substantially comprised between 1 second and 10 seconds.

According to one possibility, a detection of a start and/or of an end of transmission of the application datum A on the application carrier frequency fpa is done prior to the computation SS6 of the piece of information PER relating to the quality of the transmission of the application datum on the application carrier frequency.

The piece of information PER is received by the device Prim upon a step of receiving SP8 the piece of information PER relating to the quality of the transmission of the application datum A emitted by the primary communication device Prim on the application carrier frequency fpa, originating from the at least one secondary communication device Sec and/or the primary communication device proceeds with the computation SP9′ of a piece of information PER relating to the quality of the transmission of the application datum A emitted by the at least one secondary communication device Sec on the application carrier frequency fpa following the reception of the application datum A during Step SP9.

Afterwards, the primary communication device proceeds with carrying out SP10 an application diagnostic on the application carrier frequency fpa based on the piece of information PER relating to the quality of the transmission of the application datum A on the application carrier frequency fpa, and then with the update SP11 of the subgroup of carrier frequencies P2 based on the application diagnostic on the application carrier frequency fpa.

Thus, the primary communication device Prim has access to the information PER relating to the communications emitted and received by the communication device Prim and by the group of secondary communication devices.

And steps SP5 and SP6 of the method are carried out again.

According to one possibility, the update SP11 of the subgroup P2 of carrier frequencies comprises a reclassification of the application carrier frequency fpa based on the piece of information PER in the subgroup of carrier frequencies P2 if the piece of information PER relating to the application carrier frequency fpa has an insufficient quality, for example if it exceeds 10% of the total number of radio packets received by a device.

If, on the contrary, the piece of information PER has a sufficient quality, in other words if it is less than 10% of the total number of radio packets received by a device, then the transmission of the application datum A continues on the application frequency fpa.

The analysis of the quality of the transmission of the application datum A is performed according to two approaches:
A so-called “opportunistic” approach: when a user of a radio-communication device, for example a referee, emits a sound signal, the application datum transmitted on an application carrier frequency is used to compute the piece of information PER on said application carrier frequency. Thus, a clear indication is obtained on the quality of the communication link between all radio-communication devices
A so-called “controlled and periodical” approach: this approach is adopted in the absence of a transmission of an application signal for example an audio signal within the radio-communication system S, the application radio packets may then be used for the transmission of non-application data over several consecutive radio cycles CR, so as to simulate a communication and thus cause the computation of BER.

Thus, each communication device is capable of:

1. Assessing the quality of the communication link with the other communication devices within the radio-communication system including the communication devices that do not emit any application datum.

2. Periodically assessing the quality of the communication link in order to foresee a possible communication problem.

3. Accurately identifying the nature of disturbers.

When a communication device emits the application datum A, the radio packet containing this application datum further contains a piece of information relating to a number of radio packets containing the application datum that are consecutive to said radio packet.

The piece of information relating to a number of radio packets containing the application datum A is computed by the communication device which emits the radio packet containing the application datum.

Each communication device that receives a radio packet containing the application datum A could predict the number of radio packets that will follow from the same emitter communication device. Henceforth, the communication device is capable of detecting that a radio packet has not been received, in particular because of radio-frequency disturbances.

The at least one secondary communication device Sec transmits the piece of information PER to the primary communication device Prim, for example when the primary communication device Prim requests so.

In the described radio-communication method, the communication devices assess the presence of radio disturbances in the various radio channels authorized by the local regulations without interrupting the transmission of the application datum A.

The communication devices are further capable of determining, in a standalone manner, when the radio-communication system S leaves its steady regime and the communications become disturbed.

Sharing of information originating from the group of secondary communication devices then enables the primary communication device Prim to review the group of carrier frequencies on which it is possible to transmit a signal without any radio disturbance.

The primary communication device Prim concentrates the information PER and BER of all communication devices in the radio-communication system S.

A sorting and detection algorithm allows detecting a possible degradation of the communication link on the application carrier frequencies.

Starting from the piece of information BER, the primary communication device Prim is capable of sorting the carrier frequencies and rejecting the transmission of the signal on those having an insufficient quality information BER, for example if it exceeds 10% of the total number of radio packets received by a device.

According to one possibility, the primary communication device Prim receives a piece of information RSSI in addition to the piece of information BER originating from the at least one secondary communication device.

According to one possibility, the radio-communication system S may contain a plurality of primary communication devices.

Update of the Groups of Carrier Frequencies

The primary communication device Prim and/or the at least one secondary communication device Sec are capable of identifying, in a standalone manner, in other words without any intervention from outside the radio-communication system S, in particular that of an operator, when the transmission of a signal on the carrier frequency fp is disturbed.

In the context of the invention, the radio packets containing the application datum A are called application radio packets.

Each communication device assesses the quality of the signal that is transmitted thereto by another device and computes the piece of information PER relating to the quality of the transmission of the application datum A in two different ways:
An instantaneous computation (in about one second for an audio signal for example): when an error rate of 20% for example for the transmitted application radio packets is measured, a request for selecting a new application carrier frequency is generated
A long-term computation (in about ten seconds for an audio signal for example): when an error rate of 10% for example for the transmitted application radio packets is measured, a request for selecting a new application carrier frequency is generated.

Assignment of a Mark

The step of extracting SP4 the subgroup of carrier frequencies P2 will now be described in more detailed way according to an example of implementation. This step further includes the following substeps:
Assigning SP4-1 a partial mark for each secondary communication device Sec comprised in the group of secondary communication devices for the at least one carrier frequency fp comprised in the group of carrier frequencies P1 from the piece of information BER relating to the quality of the communication link on said carrier frequency fp received from said secondary communication device Sec;
Determining SP4-2 an overall mark for the at least one carrier frequency fp comprised in the group of carrier frequencies P1 from a plurality of partial marks for the carrier frequency fp obtained for a plurality of secondary communication devices comprised in the group of secondary communication devices;
Classifying SP4-3 the at least one carrier frequency fp in the subgroup of carrier frequencies P2 based on the overall mark for the at least one carrier frequency fp.

According to one possibility, the subgroup of carrier frequencies P2 contains a number of carrier frequencies smaller than or equal to the number of carrier frequencies contained in the group of carrier frequencies P1.

In other words, the at least one carrier frequency fp may be added to or removed from the subgroup of carrier frequencies P2 according to the overall mark for said at least one carrier frequency fp.

Moreover, the step of determining an overall mark for a frequency may comprise a step of excluding at least one secondary communication device Sec based on the partial mark assigned for the computation of the overall mark for the at least one carrier frequency fp comprised in the group of carrier frequencies P1.

According to these arrangements, a secondary communication device Sec that has a bad mark for all carrier frequencies is excluded from the computation or from the determination of the computation of the overall mark.

Upon the transmission of a signal, an overall mark is assigned to a carrier frequency according to the losses of radio packets on said carrier frequency as well as the duration of these losses.

FIG. 6 presents an example of assignment of the overall mark for a given carrier frequency.

Carrier frequencies F1, F2, F3, F4 are sorted according to the overall mark assigned thereto in [Tab.1]: the greater the mark of a carrier frequency, the lesser it will be recommended to select this carrier frequency for the transmission of the signal.

The carrier frequencies for which a 0 mark is assigned may be primarily used.

FIG. 6 is a graph which presents a severity of the losses L of radio packets PR as a function of a duration tL during which these losses are observed, as well as a system for assigning a partial mark for a given carrier frequency: an area Z3 of the graph is equivalent to a partial mark of 3, an area Z2 to a partial mark of 2, an area Z1 to a partial mark of 1 and an area Z0 to a partial mark of 0. A partial mark of 0 for a given carrier frequency indicates that the frequency fp could be preferred for the transmission of the signal.

The overall marks of the carrier frequencies are concentrated by the primary communication device Prim in order to select a carrier frequency for the transmission of the signal.

Before computing the overall mark for each carrier frequency, a partial mark is assigned to each secondary communication device in the group of secondary devices.

Upon the computation of the overall mark for each carrier frequency, a secondary communication device having an insufficient partial mark on each carrier frequency is excluded from the computation of the overall mark of each carrier frequency.

The table [Tab.1] presents an example of assignment of the overall mark for the carrier frequencies F1, F2, F3 and F4 for secondary communication devices Sec1, Sec2, Sec3, Sec4 and Sec5.

TAB 1

| | Score/channel | | | | |
|---|---|---|---|---|---|
| No. of the | | | | | Overall mark/ |
| device | F1 | F2 | F3 | F4 | device |
| Sec1 | 0 | 1 | 1 | 2 | 1/4 >= 2 |
| Sec2 | 0 | 0 | 2 | 3 | 2/4 >= 2 |
| Sec3 | 0 | 1 | 1 | 3 | 1/4 >= 2 |
| Sec4 | 0 | 1 | 2 | 2 | 2/4 >= 2 |
| Sec5 | 3 | 3 | 3 | 3 | 4/4 frequencies |
| | | | | | >= 2 |
| Overall mark/ | 0 | 3/4 | 6/4 > | 10/4 > | |
| channel | | | 1 | 1 | |

The carrier frequencies F1, F2, F3, F4 are sorted according to their overall mark: When a carrier frequency is deemed to be not usable, a sort request P2R is launched. The carrier frequencies for which an analysis is ongoing in order to assign an overall mark thereto are integrated to a group of carrier frequencies P1. The carrier frequencies for which the overall mark is greater than 1 are not suggested for the transmission of the signal.

The carrier frequencies F1 and F2 for which the lowest overall marks have been assigned are selected by the primary communication device for sending the application datum A. F1 and F2 are then integrated to the subgroup of carrier frequencies P2.

According to one example, the case where the radio-communication system S analyses four frequencies f1, f2, f3, f4 contained in frequency bands authorized by the regulations in force, for example the ISM frequency bands, is considered.

Sending of information within the system S starts randomly on any of these frequencies, for example f1, because a user has decided not to select a specific frequency.

Before any information is sent between the communication devices, an analysis of the frequency bands takes place.

This analysis continues as long as the devices are turned ON.

Thus, the system S understands, at any time, which ones among f1, f2, f3 and f4 could be exploited should the used frequency has to be modified.

During the phases of sending the application datum A, each communication device measures the quality of the radio link between itself and the devices that are transmitting.

A diagnostic of the piece of information BER is permanently performed and a diagnostic of the piece of information PER is performed upon sending the application datum A.

If the result of the diagnostic of the piece of information PER is not acceptable, the communication between the devices of the system S is disturbed, and thus it could be decided to toggle from f1 to f2, f3 or f4: the selection being determined by the best result of the diagnostic of the piece of information BER:
This toggle is controlled by the primary communication device which propagates an order to the other devices.
In practice, the piece of information PER which triggers toggling of the operation of the system S on a different frequency will be selected so as not to generate untimely changes, while being sensitive enough so as not to authorize a considerable degradation of sending of the application datum A. for example, a computed piece of information PER that exceeds 5% over more than 10 consecutive seconds of communication represents an acceptable tradeoff.

In the case where the application datum A is an audio signal for example, the computed piece of information PER may have a value ranging up to 5% or 10%, and “packet loss concealment” type audio processing mechanisms allow maintaining a satisfactory audio quality. Disturbances relating to the piece of information PER having a value up to 5% or 10% reveal a radio-frequency congestion, a sign of a cohabitation in the used channel.

State Machine

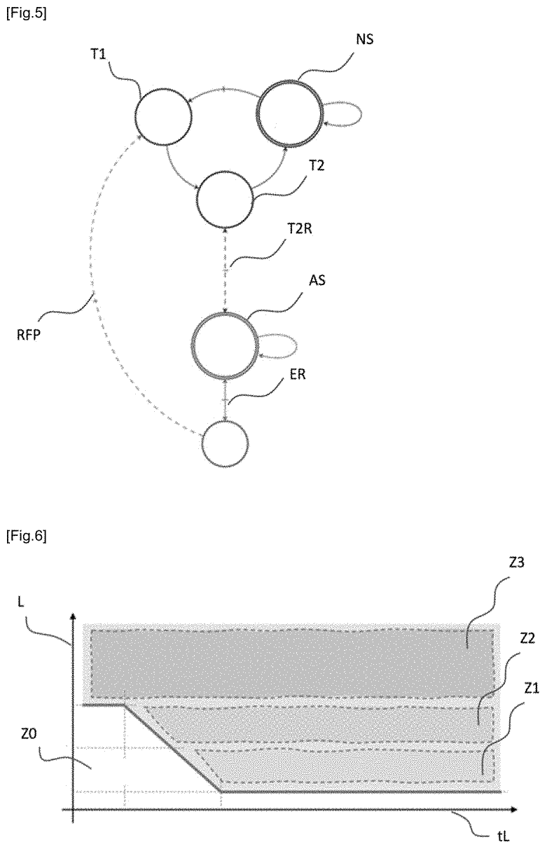

FIG. 5 is a representation of the method described with reference to FIG. 4 in the form of a state machine.

Thus, an active state by default of said radio-communication method is that derived from an analysis of the communication network NS.

During the state NS, the primary communication device Prim sends the information packet B on a regular basis over a plurality of carrier frequencies, and the at least one secondary communication device Sec assesses the quality of the radio packets received from the primary communication device Prim on each carrier frequency.

The state NS corresponds to an execution of steps SP1 to SP4 by the primary communication device Prim.

In FIG. 5, a state T1 represents the selection of the plurality of carrier frequencies constituting the group of carrier frequencies P1, and a state T2 represents a selection of a plurality of application carrier frequencies to constitute the subgroup of carrier frequencies P2 and corresponding to an execution of step SP4.

A transition T2R represents a selection of an application carrier frequency fpa for the transmission of the application datum A and corresponds to the execution of steps SP6 and Sp7 of FIG. 4.

A state AS is a state of analysis of the application radio packets. The state AS corresponds to the execution of steps SS6, SS7 by the at least one secondary communication device Sec and to the execution of steps SP8, SP9 and SP9′ by the primary communication device Prim.

Finally, upon a request ER for changing the application carrier frequency fpa, the rejected frequency fpa is repositioned in the group of carrier frequencies P1 upon a transition RFP and a new set of carrier frequencies is selected in the subgroup of carrier frequencies P2. This state corresponds to the execution of steps SP4 and SP5 or SP11 by the primary communication device Prim.

Adaptive Role Mechanism

In the case where no channel is completely free of disturbances, the radio-communication system S features a capability of withstanding disturbances.

In the context of the invention, a resilience of the radio-communication system S refers to a resistance of the system S to radio disturbances, in other words the radio-communication system S enables the communication devices to exploit all transmitted radio packets even when the transmitted radio packets have a n insufficient value of the piece of information PER.

According to one possibility, the described radio-communication method adapts a use of a bandwidth for the transmission of a signal so as to improve the resilience of the radio-communication system S to radio disturbances.

According to one possibility, the described radio-communication method includes a hierarchization H1 of the primary communication device Prim and of the at least one secondary communication device Sec, a prioritization H2 for the transmission of the application datum A on the application carrier frequency fpa based on the hierarchization to designate a priority communication device, a transmission H3 of the application datum A on the application carrier frequency fpa by a plurality of radio packets PR with a redundancy of the application datum A transmitted by the priority communication device.

For example, the priority communication device may refer to the communication device used by a central referee during a sporting event.

As example, during a sporting event, some communication devices might have a more important role than others, in particular in the management of a team, and therefore said communication devices are hierarchized according to the importance of their role.

When a communication device has an important role, it is said that it has a privileged role.

The communication device having a privileged role has a pre-emptive right in the transmission of a signal and priority within the radio-communication system S.

Thus, in order to guarantee the pre-emptive right of the privileged role within the radio-communication system S, an assignment of a plurality of radio packets PR for the transmission of the application datum A on the application carrier frequency fpa based on the priorization of the communication devices is performed.

The communication device having a privileged role can transmit an application datum A, for example the audio signal, with an information redundancy, also called conditional redundancy.

There are different algorithms for implementing the conditional redundancy, for example:

1. A repetition of the piece of information contained in a radio packet comprised within the plurality of radio packets PR and transmitted within the same radio cycle CR, in a different radio packet and on the same carrier frequency fp.

2. A repetition of the piece of information contained in a radio packet comprised within the plurality of radio packets PR and transmitted within the same radio cycle CR, in a different radio packet and on a different carrier frequency.

3. A use of the plurality of consecutive radio packets PR for the transmission of a piece of information already containing the information redundancy.

The algorithm of implementation of the conditional redundancy may be selected according to a nature of the radio disturbances.

Upon the implementation of the conditional redundancy, radio packets that contain a redundant transmitted piece of information are selected from radio packets containing no information to be transmitted.

Remote Mechanism for Holding in Operating Conditions

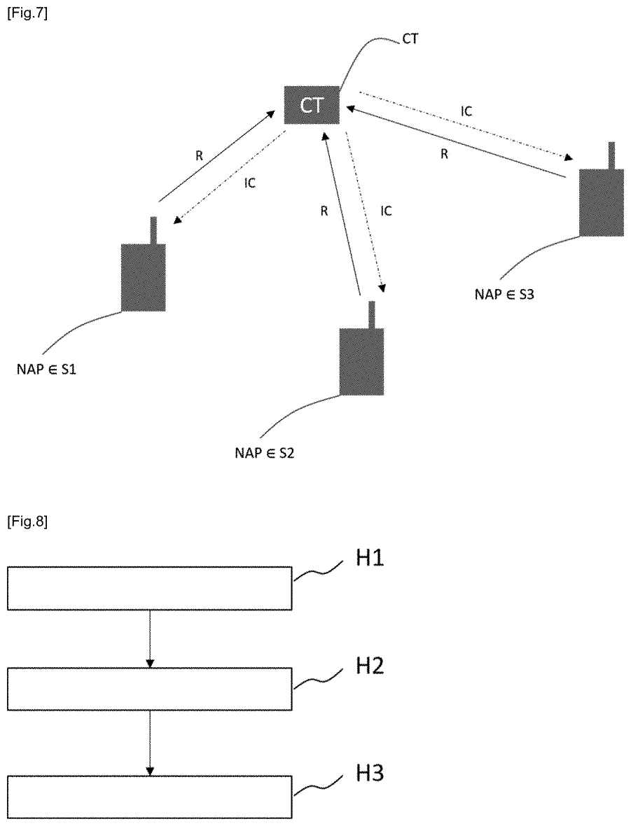

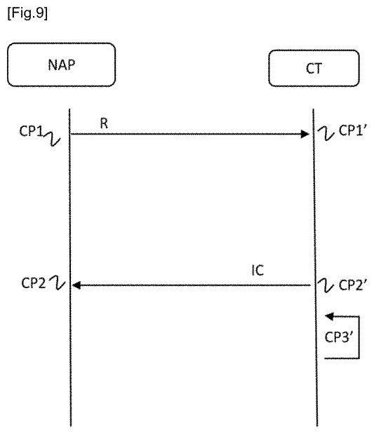

It is possible to implement for the radio-communication system S, like in FIG. 7, a method for managing an operation implementing the described radio-communication method.

According to one possibility, the radio-communication system comprises a control center CT and an information device NAP.

According to one possibility, the information device NAP creates a server, accessible locally for example from the compound of a football stadium or remotely for example from the control center CT.

The server makes information on a state of the radio-communication system S available, in other words a piece of information R relating to the operation of the radio-communication system S, for example a battery life, a sound level of a headset, a type of a used headset, an audio quality, a presence of radio disturbers, etc., and enables the control center CT to check up a proper operation of the radio-communication system S.

Should a problem arise, the control center CT is capable of remotely changing a configuration of the communication devices, for example by forcing a use of a different carrier frequency for the signal to be transmitted.

Thus, the method for managing an operation of the system for radio-communication S between the primary communication device Prim and the at least one secondary communication device Sec comprises the following steps
Receiving CP1′ a piece of information R relating to the operation of the radio-communication system S by the control center CT;
Sending CP2′ a piece of information IC relating to a management operation of the radio-communication system S based on the piece of information R relating to the operation of the radio-communication system S for a modification CP3′ of the operation of the primary radio-communication device Prim and/or of the group of secondary radio-communication devices Sec based on the piece of information IC.

The piece of information R relating to the operation of the radio-communication system may be received from the information device NAP belonging to the radio-communication system S.

The objective of the described management method is to enable the control center CT to manage several radio-communication systems S1, S2, S3 by remotely acting so as to solve any problems within said radio-communication systems.

According to one possibility, the described management method features an automatic and manual “reporting” function, to rebuild a progress of a scene, in particular a scene of a sporting event.

According to one possibility, the server may embed data processing algorithms, for example algorithms using machine learning approaches, in order to process large amounts of data relating to various characteristics of the radio-communication system.

According to one possibility, the system S does not operate on frequencies used by some sporting clubs for their specific communication systems.

According to one possibility, the system S does not operate on frequencies that cannot a priori be used in some stadiums.

According to one possibility, the method for managing the operation of the radio-communication system S allows triggering a periodic diagnostic of the piece of information PER, and a warning sound in the case where a problem arises.

As example, the radio-communication system S and the described radio-communication method may be used to enable teams to talk with each other, with a good audio quality and that being so, even on extremely noisy environments. In particular, in the sporting field, the described radio-communication method and radio-communication system S allow equipping referees, trainers and physicians in their mission where the decision-making is shared, quick, unambiguous and is done most of the time under pressure and in a noisy environment (>90 dbSPL).

Although the invention has been described in connection with the particular embodiments, it is obvious that it is not limited thereto and that it encompasses all technical equivalents of the described means as well as their combinations where these fall within the scope of the invention.

1. A method for radio-communication between a primary communication device and at least one secondary communication device the primary device may be configured to become a secondary device and vice versa, the method using an application carrier frequency for the transmission of an application datum, the method being executed by the primary communication device and comprising the following steps:
receiving a piece of information BER relating to a quality of a communication link on at least one network carrier frequency comprised in a group of carrier frequencies originating from the at least one secondary communication device;
carrying out a diagnostic of communication based on the information BER relating to the quality of the communication link on the at least one network carrier frequency;
extracting a subgroup of carrier frequencies likely to become application carrier frequencies and carry a signal to be transmitted from the group of carrier frequencies;
selecting the application carrier frequency in the subgroup of carrier frequencies;
establishing an application communication between the primary communication device and the at least one secondary communication device on the application carrier frequency.

2. The method according to claim 1, further comprising the following step:
sending an information packet on the at least one carrier frequency comprised in the group of carrier frequencies by the primary communication device towards the at least one secondary communication device.

3. The method according to claim 1, wherein the radio-communication is carried out between a primary communication device and a group of secondary communication devices, the extraction of the subgroup of carrier frequencies being done according to the following steps: assigning a partial mark for each secondary communication device comprised in the group of secondary communication devices for the at least one carrier frequency comprised in the group of carrier frequencies from the piece of information BER relating to the quality of the communication link on said carrier frequency received from said secondary communication device;
determining an overall mark for the at least one carrier frequency comprised in the group of carrier frequencies from a plurality of partial marks for the carrier frequency obtained for a plurality of secondary communication devices comprised in the group of secondary communication devices;
classifying the at least one carrier frequency in the subgroup of carrier frequencies based on the overall mark for the at least one carrier frequency.

4. The method according to claim 3, wherein the step of determining an overall mark for a frequency comprises the following step:
excluding at least one secondary communication device based on the partial mark assigned for the computation of the overall mark for the at least one carrier frequency comprised in the group of carrier frequencies.

5. The method according to claim 1, further comprising the following steps:
computing a piece of information PER relating to the quality of the transmission of the application datum emitted by the at least one secondary communication device on the application carrier frequency, and/or Receiving the piece of information PER relating to the quality of the transmission of the application datum emitted by the primary communication device on the application carrier frequency, originating from the at least one secondary communication device;
carrying out an application diagnostic on the application carrier frequency form the piece of information PER relating to the quality of the transmission of the application datum on the application carrier frequency;
updating the subgroup of carrier frequencies from the application diagnostic on the application carrier frequency;
the following steps of the method being carried out again:
selecting the application carrier frequency in the subgroup of carrier frequencies;
establishing an application communication between the primary communication device and the at least one secondary communication device on the application carrier frequency.

6. A method for radio-communication between a primary communication device and at least one secondary communication device, the primary device may be configured to become a secondary device and vice versa, the method using an application carrier frequency for the transmission of an application datum, the method being executed by the at least one secondary communication device and comprising the following steps:
creating a piece of information BER relating to a quality of a communication link on at least one carrier frequency comprised in a group of carrier frequencies to be transmitted to the primary communication device; sending the piece of information BER relating to the quality of the communication link on at least one carrier frequency comprised in the group of carrier frequencies to the primary communication device.

7. The method according to claim 6, further comprising the following steps of:
receiving an information packet on the at least one carrier frequency comprised in the group of carrier frequencies originating from the primary communication device;
configuring the at least one secondary communication device based on the information packet on the at least one carrier frequency comprised in the group of carrier frequencies originating from the primary communication device;
synchronizing the at least one secondary communication device with the primary communication device based on the information packet on the at least one carrier frequency comprised in the group of carrier frequencies originating from the primary communication device.

8. The method according to claim 6, further comprising the following steps of:
computing a piece of information PER relating to a quality of a transmission of an application datum emitted by the at least one secondary communication device on the application carrier frequency;
sending the piece of information PER relating to the quality of the transmission of the application datum emitted by the at least one secondary communication device on the application carrier frequency to the primary communication device.

9. A method for radio-communication according to claim 1 between a primary communication device and at least one secondary communication device, the method using an application carrier frequency for a transmission of an application datum, the transmission of the application datum being done by a plurality of radio packets, the method being executed by the primary communication device and comprising the following steps:
a hierarchization of the primary communication device and of the at least one secondary communication device;
a prioritization for the transmission of the application datum on the application carrier frequency based on the hierarchization to designate a priority communication device;
a transmission of the application datum on the application carrier frequency by a plurality of radio packets with a redundancy of the application datum transmitted by the priority communication device.

10. A method for managing an operation of a system for radio-communication between a primary communication device and at least one secondary communication device, the primary communication device implementing a radio-communication method according to claim 1 and/or the secondary communication device implementing a radio-communication method between a primary communication device and at least one secondary communication device, the primary device may be configured to become a secondary device and vice versa, the method using an application carrier frequency for the transmission of an application datum, the method being executed by the at least one secondary communication device and comprising the following steps:
creating a piece of information BER relating to a quality of a communication link on at least one carrier frequency comprised in a group of carrier frequencies to be transmitted to the primary communication device;
sending the piece of information BER relating to the quality of the communication link on at least one carrier frequency comprised in the group of carrier frequencies to the primary communication device the system comprising a control center, the method being executed by the control center and comprising the following steps:
receiving a piece of information relating to the operation of the radio-communication system by the control center;
sending a piece of information relating to a management operation of the radio-communication system based on the piece of information relating to the operation of the radio-communication system for a modification of the operation of the primary radio-communication device and/or of the group of secondary radio-communication devices based on the piece of information.

11. The method according to claim 10, wherein the piece of information relating to the operation of the radio-communication system is received from an information device belonging to the radio-communication system.
